(19) United States
(12) Patent Application Publication
(10) Pub. No.: US 2024/0159902 A1
(43) Pub. Date: May 16, 2024

(54) DISTANCE MEASUREMENT DEVICE, DISTANCE CORRECTION METHOD, AND NON-TRANSITORY COMPUTER-READABLE STORAGE MEDIUM

(71) Applicant: Hitachi-LG Data Storage, Inc., Tokyo (JP)

(72) Inventors: Katsumi ITO, Tokyo (JP); Hisataka SUGIYAMA, Tokyo (JP); Katsuhiko IZUMI, Tokyo (JP)

(21) Appl. No.: 18/378,466

(22) Filed: Oct. 10, 2023

(30) Foreign Application Priority Data
Nov. 15, 2022 (JP) 2022-182876

(51) Int. Cl. G01S 17/10; G01S 7/4861; G01S 7/497

(52) U.S. Cl. CPC G01S 17/10; G01S 7/4861; G01S 7/497

(57) ABSTRACT

A distance measurement device comprises an irradiation unit that irradiates a measurement light onto an object to be measured, a light receiving sensor that receives reflected light from the object to detect an exposure amount based on the reflected light, a memory unit that stores correction information indicating a correction formula set including a plurality of correction formulas and an applicable distance range of each correction formula, and a distance calculation unit that calculates the measurement distance to the object to be measured based on the exposure amount. The distance calculation unit performs, based on the correction information stored in the memory unit, a distance correction calculation to calculate a corrected measured distance by correcting the measured distance using the correction formula corresponding to the applicable distance range in which the measured distance is included among the plurality of correction formulas in the correction formula set.

### CROSS-REFERENCE TO RELATED APPLICATION

The present application claims priority from Japanese application JP2022-182876, filed on Nov. 15, 2022, the content of which is hereby incorporated by reference into this application.

### BACKGROUND OF THE INVENTION

### Field of the Invention

The present invention relates to a distance measurement device, a distance correction method, and a non-transitory computer-readable storage medium.

### Description of the Related Art

Patent Document 1 (Japanese Unexamined Patent Application Publication No. 2021-117036) discloses a measurement correction method of a distance measurement device for correcting distance error caused by multipath phenomenon (hereinafter, the measurement correction method is referred to as a “conventional technology”). The multipath phenomenon is a phenomenon in which the optical path length appears to be longer due to unwanted reflections from walls, floors, etc., when used in an environment where materials with high reflectance are used such as walls, floors, etc.

TOF (Time Of Flight) is a distance measurement device that measures distance by measuring the time it takes for infrared light emitted from a laser to reflect off an object and return to a light receiving element. Based on this principle of TOF, in an environment strongly affected by multipath, the distance measured by TOF becomes longer than the actual distance to the object to be measured, and thus a distance error occurs.

In contrast, the conventional technology places the measurement sample so that the distance from the distance measurement device becomes a set value L1 as a preparation process. The conventional technology measures the distance to the measurement sample by the distance measurement device to obtain a measured value L2.

The conventional technology obtains the measured value L2 corresponding to the set value L1 in multiple ways while changing the set value L1. The conventional technology generates a correction formula to convert the measured value L2 to the set value L1 based on the relationship between the acquired multiple set values L1 and the multiple measured values L2. As an actual measurement process, the conventional technology corrects a distance to the object measured by the distance measurement device with the correction formula and calculates a correction value for the measured distance.

However, the conventional technology requires the operator to repeatedly perform the operations of placing the measurement sample and measuring the distance from the distance measurement device to the measurement sample in order to generate a correction formula, which is time-consuming and labor-intensive and troublesome.

### SUMMARY OF THE INVENTION

The present invention has been made to solve the above problems. That is, one of the objects of the present invention is to provide a distance measurement device, a distance correction method, and a non-transitory computer-readable storage medium that can easily correct distance error caused by the multipath phenomenon.

To solve the above problem, the distance measurement device comprises:
an irradiation unit that irradiates measurement light onto an object to be measured;
a light receiving sensor that receives reflected light from the object to be measured and detects an exposure amount based on the reflected light; and
a control unit that includes a memory unit that stores correction information indicating a correction formula set including a plurality of correction formulas and an applicable distance range of each correction formula, and calculates a measured distance to the object to be measured based on the exposure amount. The control unit is configured to perform, based on the correction information stored in the memory, a distance correction calculation to:
select the correction formula that corresponds to the applicable distance range in which the measured distance is included among the correction formulas in the correction formula set; and
calculate a corrected measured distance by correcting the measured distance using the selected correction formula.

The distance correction method applies to a distance measurement device comprising:
an irradiation unit that irradiates measurement light onto an object to be measured;
a light receiving sensor that receives reflected light from the object to be measured and detects an exposure amount based on the reflected light; and
a control unit that includes a memory unit that stores correction information indicating a correction formula set including a plurality of correction formulas and an applicable distance range of each correction formula, and calculates a measured distance to the object to be measured based on the exposure amount. The distance correction method is performed using the control unit. The distance correction method comprises:
selecting, based on the correction information stored in the memory, the correction formula that corresponds to the applicable distance range in which the measured distance is included among the correction formulas in the correction formula set; and
calculating a corrected measured distance by correcting the measured distance using the selected correction formula.

The non-transitory computer-readable storage medium stores a computer-executable program executed by a control unit of a distance measurement device comprising:
an irradiation unit that irradiates measurement light onto an object to be measured;
a light receiving sensor that receives reflected light from the object to be measured and detects an exposure amount based on the reflected light; and
the control unit that includes a memory unit that stores correction information indicating a correction formula set including a plurality of correction formulas and an applicable distance range of each correction formula, and calculates a measured distance to the object to be measured based on the exposure amount. The program comprises instructions for:
selecting, based on the correction information stored in the memory, the correction formula that corresponds to the applicable distance range in which the measured distance is included among the correction formulas in the correction formula set; and
calculating a corrected measured distance by correcting the measured distance using the selected correction formula.

According to the present invention, distance error caused by multipath phenomena can be easily corrected.

### BRIEF DESCRIPTION OF DRAWINGS

FIG. 1 shows an example configuration of a distance measurement device according to a first embodiment of the present invention.

FIG. 2 illustrates the principle of distance measurement of a distance measurement device.

FIG. 3 shows the relationship between the actual distance and the measured distance.

FIG. 4 illustrates the mechanism of measurement error caused by multipath effects.

FIG. 5A shows the relationship between an ideal actual distance and a measured distance and the relationship between the actual distance and the measured distance when affected by multipath.

FIG. 5B shows the relationship between the actual distance and the error in the measured distance.

FIG. 6A shows an approximate model that approximates the relationship between the actual distance and the error in the measured distance.

FIG. 6B is a graph to illustrate the correction formula for the measured distance.

FIG. 7 illustrates the correction table.

FIG. 8 is a flowchart showing the processing flow executed by a distance calculation unit.

FIG. 9A shows the relationship between actual distance and measurement error for each installation environment.

FIG. 9B shows an approximate model that approximates the relationship between actual distance and measurement error for each installation environment.

FIG. 10 is a graph to illustrate the correction formula for the measured distance for each installation environment.

FIG. 11 illustrates the correction table.

FIG. 12 shows an example of a GUI screen.

FIG. 13A is a flowchart showing the processing flow of the setting process of the correction formula executed by the distance calculation unit.

FIG. 13B is a flowchart showing the processing flow executed by the distance calculation unit.

FIG. 14 illustrates how the correction formula is generated.

FIG. 15A is an overview of the distance measurement device according to a third embodiment of the present invention.

FIG. 15B is an overview of the distance measurement device according to the third embodiment of the present invention.

FIG. 16 is a flowchart showing the processing flow of the setting process of the correction formula executed by the distance calculation unit.

FIG. 17 is a flowchart showing the processing flow executed by the distance calculation unit.

FIG. 18 shows an overview of the distance measurement device according to a fourth embodiment of the present invention.

FIG. 19 shows an example configuration of a distance measurement device according to the fourth embodiment of the present invention.

FIG. 20 is a flowchart showing the processing flow of the setting process of the correction formula executed by the distance calculation unit.

FIG. 21 is a flowchart showing the processing flow executed by the distance calculation unit.

FIG. 22 shows an approximate model of the relationship between actual distance and measurement error.

### DETAILED DESCRIPTION OF THE EMBODIMENT

Each embodiment of the present invention will be described below with reference to the drawings. In all figures of the embodiments, identical or corresponding parts may be marked with the same symbol. In the following description, expressions such as “name” are used to describe identification information, but may be replaced by other identification information (e.g., identification number, etc.). In the following descriptions, expressions such as “table” and “record” may be used to describe various types of information, but various types of information may be expressed in data structures other than these. In the following description, the processing may be described with the functional block as the subject, but the subject of the processing may be a CPU or a device instead of a functional block.

### First Embodiment

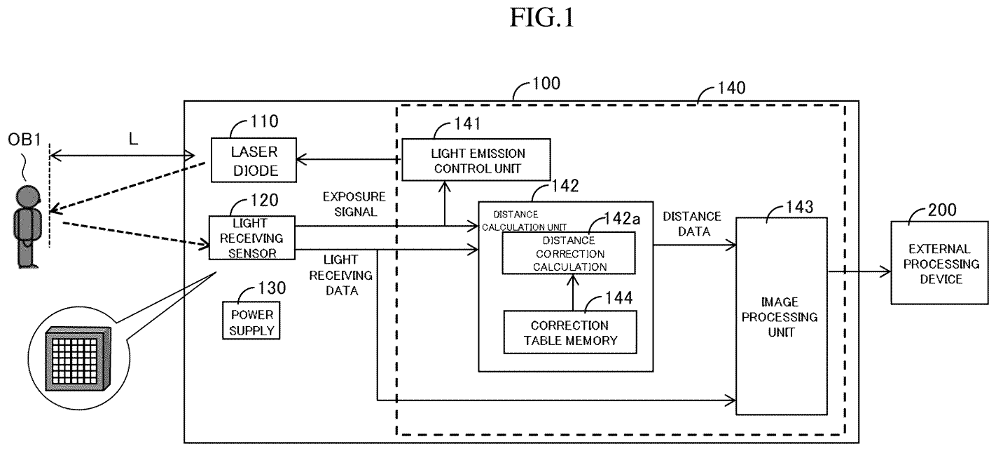

FIG. 1 shows an example configuration of a distance measurement device 100 according to a first embodiment of the present invention. As shown in FIG. 1, the distance measurement device 100 includes a laser diode 110, a light receiving sensor (photodetector) 120, a power supply 130, and a control unit 140. The distance measurement device 100 is connected to an external processing device 200, which can send and receive information to and from each other. The laser diode 110 is a light source that functions as an irradiation unit to irradiate a measurement object OB1 with pulsed light of wavelengths in the infrared region as a measurement light.

The light receiving sensor 120 includes an image sensor (e.g., CCD (Charge Coupled Device) or CMOS (Complementary Metal Oxide Semiconductor) that converts the received light into an electrical signal by photoelectric conversion and outputs it. The image sensor includes a plurality of pixels arranged in a grid pattern and a well-known readout circuit and the like. The light receiving sensor 120 generates and outputs an exposure signal indicating exposure and non-exposure operations. The light receiving sensor 120 receives light reflected by the measurement object OB1 from the pulse light emitted from the laser diode 110.

The power supply 130 provides power to drive the distance measurement device 100.

The control unit 140 includes a light emission control unit 141, a distance calculation unit 142, and an image processing unit 143. The control unit 140 can be configured by a computer including a processor such as a CPU and a memory or other storage device (storage medium). The CPU reads and executes a program stored in the memory to realize each function of the light emission control unit 141, the distance calculation unit 142, and the image processing unit 143. The control unit 140 can be configured in part or in whole by hardware. For example, the control unit 140 may use an FPGA (Field Programmable Gate Array) or the like to realize at least a part of the functions of the light emission control unit 141, the distance calculation unit 142, and the image processing unit 143.

The light emission control unit 141 controls the emission time and the turn-off time of the pulse light (rectangular pulse light) output by the laser diode 110 based on the exposure signal. It should be noted that the light emission control unit 141 may output light emission signals to the laser diode 110 and output the exposure signal indicating the exposure operation and the non-exposure operation to the light receiving sensor 120, so as to control the emission time and the turn off time of the laser diode 110 and the exposure operation and the non-exposure operation of the light receiving sensor 120.

The light receiving sensor 120 detects the reflected light reflected by the pulse light at the measurement object OB1. The light receiving sensor 120 exposes the reflected light at the timing when the exposure signal indicates the exposure operation, and converts the amount of exposure (amount of electric charge) at each pixel position of the light receiving sensor 120 into an electric signal and outputs it (as light receiving data).

The distance calculation unit 142 calculates the distance to the measurement object OB1 based on the electrical signal (exposure) from the light receiving sensor 120. The distance calculation unit 142 calculates the distance to the measurement object OB1, for example, based on the measurement principle described below. It should be noted that the distance to the measurement object OB1 before this correction is referred to as a “measurement distance or measured distance”.

The distance calculation unit 142 includes a correction table memory 144. The correction table memory 144 is composed of, for example, a nonvolatile storage device (storage medium) capable of reading and writing data. The correction table memory 144 may also be referred to as the “memory unit” for convenience. The correction table memory 144 stores correction information indicating “a plurality of correction formulas (two correction formulas in this example) and the applicable range of each correction formula”. The details of this correction information will be described below. The “multiple correction formulas and the applicable range of each correction formula” may also be referred to as a “set of correction formulas” for convenience. The “applicable range of correction formula” refers to the range of measurement distance to which the correction formula are applied, and may also be referred to as the “applicable range of the correction formula.

The distance calculation unit 142 performs distance correction calculation 142a. Specifically, the distance calculation unit 142 corrects the measured distance by applying the measured distance for each pixel to the correction formula generated (set) based on the correction information stored in the correction table memory 144, and calculates the corrected distance for each pixel. The distance calculation unit 142 transmits the calculated corrected distance for each pixel as distance data to the image processing unit 143. The distance correction calculation 142a may also be referred to as “distance correction calculation” for convenience. The corrected distance may also be referred to as the “corrected measured distance” for convenience.

The image processing unit 143 generates a distance image based on the distance data and outputs the generated distance image to the external processing device 200. The image processing unit 143 may generate an infrared image (IR image) based on the light receiving data and output the generated IR image to the external processing device 200.

The external processing device 200 is a computer, such as a personal computer (PC). The external processing device 200 uses the distance image input from the image processing unit 143. For example, a display (not shown) is connected to the external processing device 200, and the external processing device 200 displays the input distance image on the display. The external processing device 200 may also use the infrared image (IR image) input from the image processing unit 143.

### Details of the Problem of the Present Invention

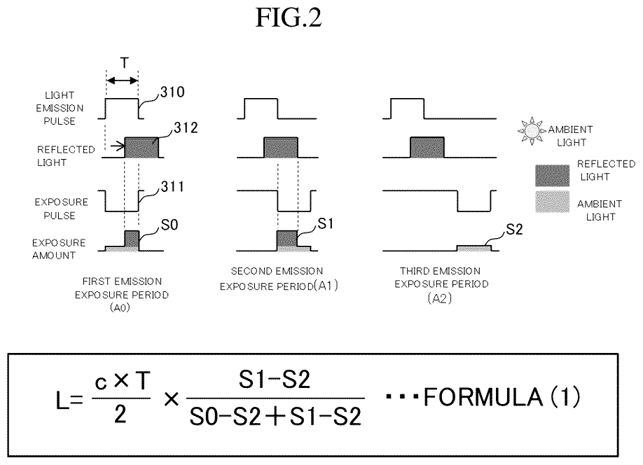

To facilitate understanding of the present invention, we will now describe the details of the problem of the present invention. FIG. 2 illustrates the principle of distance measurement of the distance measurement device 100.

The light emission control unit 141 of the control unit 140 controls the light emission timing of the laser diode 110. The light receiving sensor 120 generates the exposure signal (exposure pulses) indicating exposure and non-exposure operations. The emission and exposure pulses have a pulse width T. The amount of reflected light exposure received during the pulse width T of the exposure pulse is converted into an electrical signal.

The emission exposure period for measuring distance includes a first emission exposure period (A0), a second emission exposure period (A1), and a third emission exposure period (A2).

In the first emission exposure period (A0), the emission and exposure pulses are synchronized. In the second emission exposure period (A1), the exposure pulse is delayed in phase by time T from the light emission pulse. In the third emission exposure period (A2), the exposure pulse is delayed in phase by a predetermined time longer than T than the light emission pulse. In this case, a distance L to the measurement object OB1 can be calculated by the formula (1) in FIG. 2 (in the formula (1), c indicates the light speed. S0 indicates the exposure amount in the first emission exposure period (A0), S1 indicates the exposure amount in the second emission exposure period (A1), S2 indicates the exposure amount in the third emission exposure period (A2). In the third emission exposure period (A2), the light emission pulse may be off.

If the distance measurement device 100 is installed in an ideal environment (ideal condition), only the reflected light 312 of the pulse light emitted from the laser diode 110 is used for distance calculation, so the reflected light changes continuously as the distance to the measurement object OB1 changes.

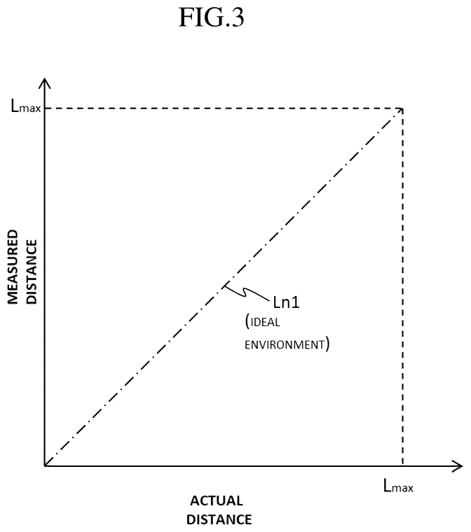

Therefore, when the installation environment of the distance measurement device 100 is ideal (ideal condition), there is no error between the actual distance and the measured distance, as shown by the single-dot line Ln1 in FIG. 3, and the linearity of the relationship between the actual distance and the measured distance (hereinafter also referred to as “linearity of distance measurement results”) is ensured.

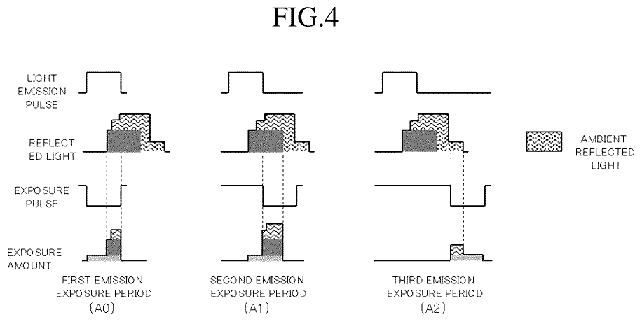

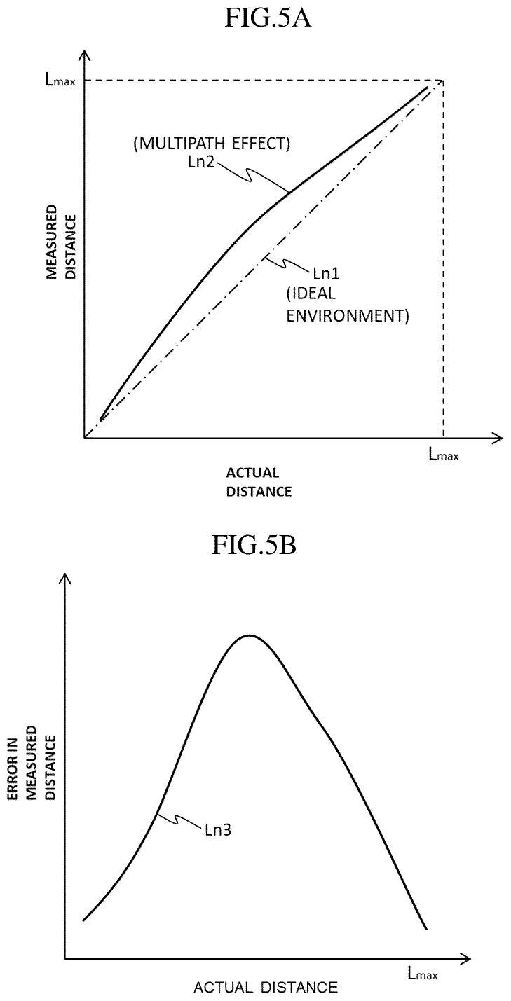

However, according to the results verified by the inventor, when the distance measurement device 100 is used in an environment strongly affected by multipath, the amount of exposure used for distance calculation is affected by ambient reflected light, as shown in FIG. 4. As a result, the linearity of the distance measurement results is impaired, as shown by the solid line Ln2 in FIG. 5A. That is, as shown in FIG. 5A, the solid line Ln2, which shows the relationship between the actual distance and the measured distance, tends to be an arch shape with inflection points, and as shown in FIG. 5B, the solid line Ln3, which shows the relationship between the actual distance and the error in the measured distance (measurement error), tends to be an upward convex mountain shape with inflection point.

In contrast, the distance measurement device 100 according to the first embodiment of the present invention generates a plurality of correction formulas and the applicable range of each correction formula for each measurement distance range classified by inflection point in advance and stores them in the correction table memory 144 for the purpose of correcting measurement error that occur when the distance measurement device 100 is used in environments where multipath occurs.

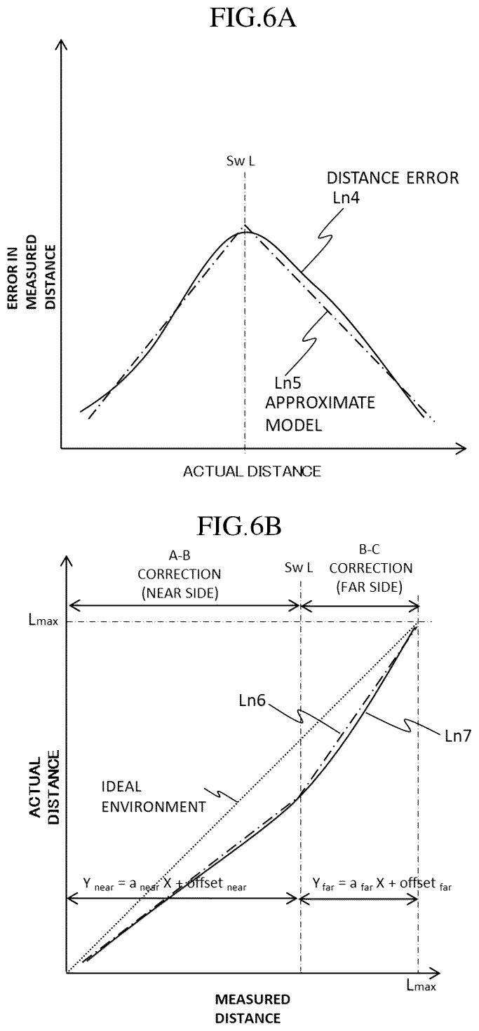

The solid line Ln4, which shows the relationship between the error in measured distance (distance error) caused by the multipath effect and the actual distance shown in FIG. 6A, is an upward convex, mountain-like curve, as previously described. Therefore, a simple approximate model of the distance error can be established as shown by two straight lines with different slopes and intercepts, indicated by the single-dotted line Ln5.

FIG. 6B shows the XY coordinate system with the measured distance on the X-axis (horizontal axis) and the actual distance on the Y-axis (vertical axis). By fitting an approximate model of the distance error to this XY coordinate system, an approximate correction formula (solid line Ln7) can be established to derive the actual distance from the measured distance. That is, the approximate model of the distance error is represented by the single-pointed line Ln6, which shows the relationship between the measured distance with distance error and the actual distance. From Ln6, approximate correction formulas (two correction formulas (Ynear=anearX+offsetnear and Yfar=afarX+offsetfar) and the range of application (the applicable range) of each correction formula) can be established to show the solid line Ln7 that shows the relationship between the measured distance and the actual distance.

The distance measurement device 100 can use this approximate correction formula (correction formula) to correct the measured distance to the actual distance (closer to the actual distance).

The two correction formulas must be used at the appropriate distance position corresponding to each correction formula. Therefore, the distance measurement device 100 uses the two correction formulas appropriately based on the measured distance (=correction switching distance SwL) corresponding to the inflection point of the solid line Ln7.

Specifically, when the measured distance is greater than 0 and less than or equal to the correction switching distance SwL, the measured distance is corrected using the correction formula Ynear=anearX+offsetnear. When the measured distance is greater than the correction switching distance SwL and within the distance range less than or equal to the maximum measurement distance Lmax, the distance measurement device 100 corrects the measured distance using the correction formula Yfar=afarX+offsetfar. Ynear and Yfar are the corrected distances corresponding to the actual distances. anear and afar and offsetnear and offsetfar are coefficients (fixed values) set in advance according to the environment in which they are expected to be used. anear and afar are different values from each other. offsetnear and offsetfar are different values from each other.

The distance measurement device 100 corrects the measured distance using the appropriate correction formula for the measured distance based on the two correction formulas (Ynear=anearX+offsetnear and Yfar=afarX+offsetfar) and the applicable range of each correction formula. This enables the distance measurement device 100 to accurately measure the distance to the measurement object OB1 by reducing the deterioration of the linearity of the distance measurement results.

<Outline of Distance Correction>

The correction table memory 144 of the distance calculation unit 142 of the distance measurement device 100 contains a correction formula (Y=aX+b), where Y is the corrected distance, X is the measured distance, and the coefficient a and b are variables, and the correction table 710.

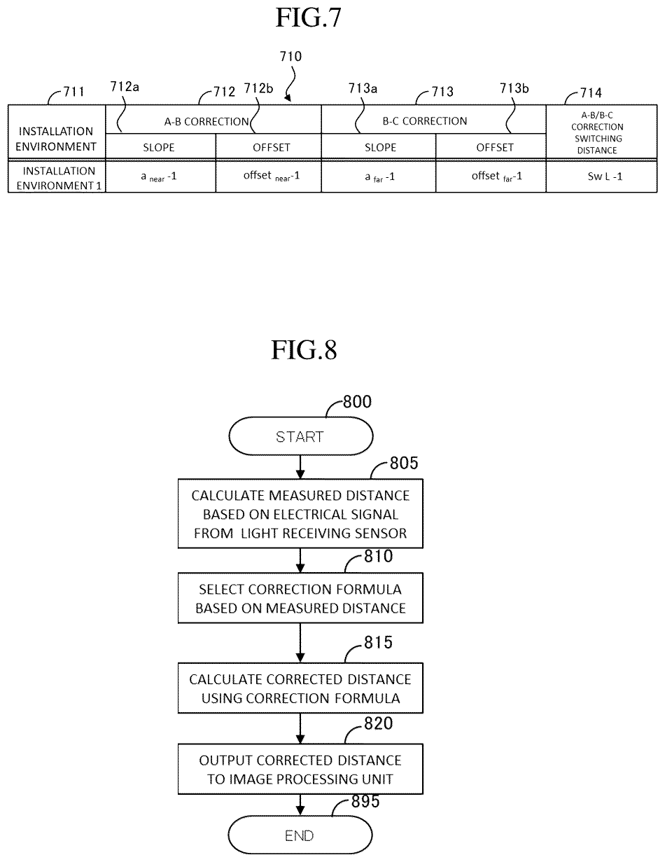

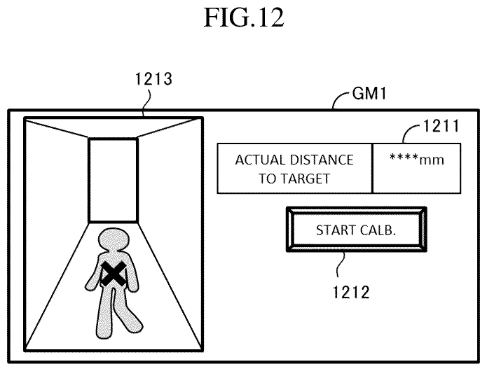

FIG. 7 illustrates the correction table 710. In FIG. 7, examples of values (numerical values) stored in the correction table 710 are shown as a combination of alphabets and numbers, etc. (e.g., “anear-1,” “offsetnear-1,” etc.) (the same in FIG. 11.)

The correction table 710 includes an installation environment 711, a between A-B correction 712, a between B-C correction 713, and an A-B/B-C correction switching distance 714 as columns (rows) that store information (values). The between A-B correction 712 includes, as sub columns (columns), a slope 712a and an offset 712b. The between B-C correction 713 includes, as sub columns, a slope 713a and an offset 713b. In the correction table 710, the information corresponding to each column for generating (setting) the correction formula and the range of application (the applicable range) of the correction formula according to the installation environment is stored in row units of information (records), which are associated with each other. This row-by-row information (record) is information for setting multiple correction formulas (two in this example) and the applicable range of each correction formula, and is referred to as “correction formula related information”.

Specifically, the installation environment 711 contains identification information (name of the installation environment) to identify the installation environment. The slope 712a contains a value applied to coefficient a of the correction formula. The offset 712b contains a value applied to coefficient b of the correction formula. In the slope 713a, the value applied to coefficient a of the correction formula is stored. In the offset 713b, the value applied to coefficient b of the correction formula is stored. In the A-B/B-C correction switching distance 714, the correction switching distance is stored.

Based on the correction switching distance, the distance calculation unit 142 sets (specifies) the distance range between A and B and the distance range between B and C, which are the measurement distance range that serves as the basis for determining which correction formula (coefficient) to apply. Specifically, the distance between A and B is set to be greater than 0 and less than or equal to the correction switching distance SwL−1, and the distance between B and C is set to be greater than the correction switching distance SwL−1 and less than or equal to the maximum measurement distance Lmax.

The distance calculation unit 142 identifies the coefficients (slope and offset) to be applied to the correction formula based on the measured distance and the correction formula with the coefficients as variables and correction table 710. The distance calculation unit 142 sets the correction formula used to correct the measured distance by applying the identified coefficients to the correction formula (Y=aX+b) with the coefficients a and b as variables.

Specifically, if the measured distance is in the A-B distance range, the distance calculation unit 142 applies the values (anear-1, offsetnear-1) stored in the slope 712a and offset 712b of the sub columns of the between A-B correction 712 in the correction table 710 to the coefficient variables of the correction formula. In this way, the distance calculation unit 142 sets the correction formula to be used for the correction. The distance calculation unit 142 corrects the measured distance using the correction formula.

If the measured distance is in the B-C distance range, the distance calculation unit 142 applies the values of the slope 713a and the offset 713b stored in the sub columns of the B-C correction 713 of the correction table 710 to the coefficient variables of the correction formula. In this way, the distance calculation unit 142 sets the correction formula to be used for the correction. The distance calculation unit 142 corrects the measured distance using the correction formula and calculates the corrected measured distance.

The correction formula with the coefficients as variables and correction table 710 are generated in advance based on the approximate model and stored in the correction table memory 144. The correction table 710 is generated based on the error between the actual distance to the target and the measured value, for example, by the operator measuring the distance to the target with the distance measurement device 100 in the installation environment where the distance measurement device 100 is expected to be used. Since the correction table 710 can be generated based on the approximate model, the correction table 710 can be generated with a small number of measurement points (actual and measured values).

<Specific Operation>

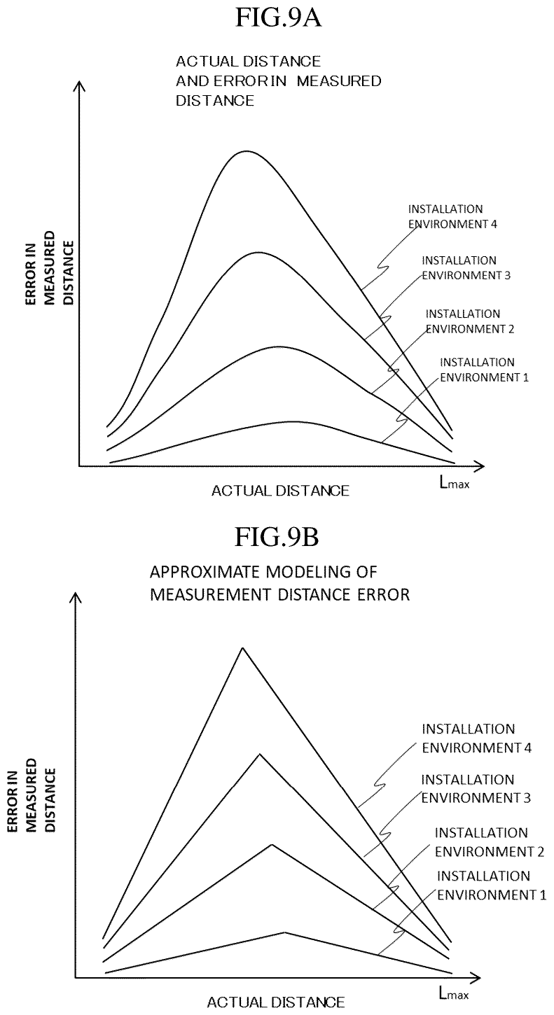

FIG. 8 is a flowchart showing the processing flow executed by the distance calculation unit 142. The distance calculation unit 142 outputs the corrected distance (distance data) for each pixel to the image processing unit 143 by executing the processing flow shown in FIG. 8 every time a predetermined time elapses.

The distance calculation unit 142 starts processing from step 800 in FIG. 8, executes steps 805 through 820 described below, and then proceeds to step 895 to tentatively terminate this processing flow.

Step 805: The distance calculation unit 142 calculates the measured distance for each pixel based on the electrical signal (exposure) from the light receiving sensor 120.

Step 810: The distance calculation unit 142 sets (selects) a correction formula to be applied based on the measured distance. Specifically, when the measured distance is between A and B, the distance calculation unit 142 sets the correction formula to be used for distance correction to the correction formula that uses the coefficients as variables to which the values of slope 712a and offset 712b stored in the between A-B correction 712 are applied. When the measured distance is between B and C, the distance calculation unit 142 sets the correction formula to be used for distance correction to the correction formula that uses the coefficients as variables to which the values of the slope 713a and the offset 713b stored in the between B-C correction 713 are applied.

Step 815: The distance calculation unit 142 calculates the corrected distance for each pixel by correcting the measured distance for each pixel using the correction formula set at step 810.

Step 820: The distance calculation unit 142 outputs the calculated corrected distance (distance data) for each pixel to the image processing unit 143.

<Effect>

As explained above, the distance measurement device 100 according to the first embodiment of the present invention maintains “a plurality of correction formulas and the applicable range of each correction formula” based on an approximate model for distance error caused by the effect of multipath, and corrects the measured distance using the correction formulas. The distance measurement device 100 sets, as correction formulas, appropriate correction formula corresponding to the behavior of the distance error for each measurement distance range due to the effect of multipath (appropriate correction formulas according to the measurement distance).

As described above, the distance measurement device 100 can easily and accurately correct distance error caused by the multipath phenomenon without the need for tedious work to generate correction formulas.

The multiple correction formulas and the applicable range of each correction formula (correction information) stored in the correction table memory 144 in advance can be generated based on an approximate model, so the multiple correction formulas and the applicable range of each correction formula (correction information) can be generated with fewer measurement points (actual measurement values and measured values).

### Second Embodiment

The distance measurement device 100 according to a second embodiment of the present invention will be described. The distance measurement device 100 according to the second embodiment of the present invention differs from the distance measurement device 100 according to the first embodiment only in the following points.

In the distance measurement device 100 according to the first embodiment, one piece of correction formula related information is stored in the correction table 710 stored in the correction table memory 144. In contrast, in the distance measurement device 100 according to the second embodiment, multiple pieces of correction formula related information (multiple correction formulas (two in this example) and information for setting the applicable range of each correction formula) are stored in the correction table 710 stored in the correction table memory 144. The distance measurement device 100 according to the second embodiment selects one piece of correction formula related information optimal for the installation environment from the correction table 710 (multiple pieces of correction formula related information) stored in the correction table memory 144, sets “multiple (in this example, two) correction formulae and the applicable range of each correction formula” optimal for the installation environment based on the selected correction formula related information, and uses the set “multiple (in this example, two) correction formulae and the applicable range of each correction formula” to correct the measurement distance.

The following explanation focuses on these differences.

<Overview>

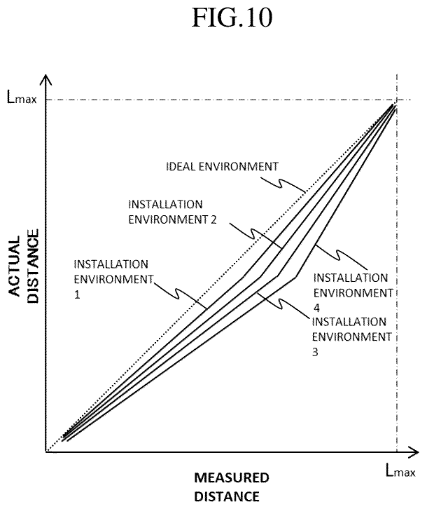

Depending on the degree of multipath influence of the installation environment of the distance measurement device 100, the degree of measurement error, which is the error in the measured distance from the actual distance, also changes. For example, as shown in FIG. 9A, the measurement errors for installation environment 1, installation environment 2, installation environment 3, and installation environment 4 are larger in installation environment 2 than in installation environment 1, larger in installation environment 3 than in installation environment 2, and larger in installation environment 4 than in installation environment 3. That is, the relationship between the measurement error of these environments is: installation environment 1<installation environment 2<installation environment 3<installation environment 4. Therefore, in order to calculate more accurate measurement distances, it is preferable to use an appropriate correction formula according to the installation environment.

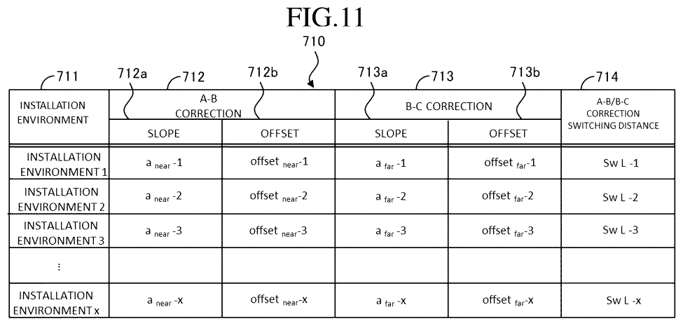

For example, as shown in FIG. 10, based on the approximate model of measurement error for each installation environment shown in FIG. 9B, “two correction formulas and the range of application (the applicable range) of each correction formula” appropriate for installation environment 1 are obtained, “two correction formulas and the range of application of each correction formula” appropriate for installation environment 2 are obtained, “two correction formulas and the range of application (the applicable range) of each correction formula” appropriate for installation environment 3 are obtained, and “two correction formulas and the range of application (the applicable range) of each correction formula” appropriate for installation environment 4 are obtained. Furthermore, although not shown in the figure, “two correction formulas and the range of application (the applicable range) of each correction formula” appropriate for each environment from installation environment 5 to installation environment x (x is any integer greater than 6) are obtained.

Information indicating multiple “two correction formulas and the applicable range of each correction formula” for each of these installation environments is stored in the correction table memory 144. The “information indicating the two correction formulas and the applicable range of each correction formula” is correction information indicating the correction formulas used for correction and the applicable range of each correction formula, and includes “a correction formula (Y=aX+b) with the coefficients as variables” and “a correction table 710 including multiple pieces of correction formula related information (information indicating the installation environment, correction formula coefficient values, and correction switching distance)”.

FIG. 11 shows an example of the correction table 710. As shown in FIG. 11, the correction table 710 is similar to the correction table 710 of the first embodiment except that correction formula related information is stored for each of multiple installation environments.

By executing the correction formula setting process in the environment where the distance measurement device 100 is installed, the “two correction formulas and the applicable range of each correction formula” optimal for the installation environment are set. It should be noted that the details of the correction formula setting process will be described below.

After the “two correction formulas and the applicable range of each correction formula” optimal for the installation environment are set, the distance measurement device 100 sets the optimal correction formula according to the measured distance and corrects the measured distance using the correction formula. This enables the distance measurement device 100 to accurately measure the distance to the measurement object OB1 by reducing the deterioration of the linearity of the distance measurement results. Since the distance measurement device 100 uses a correction formula based on information stored in the correction table memory 144 in advance according to the installation environment, there is no need for workers to generate and set correction formulas, as in Patent Document 1 (Japanese Unexamined Patent Application Publication No. 2021-117036), so the distance measurement device 100 can easily correct the distance error caused by the multipath phenomenon.

<Specific Operation>

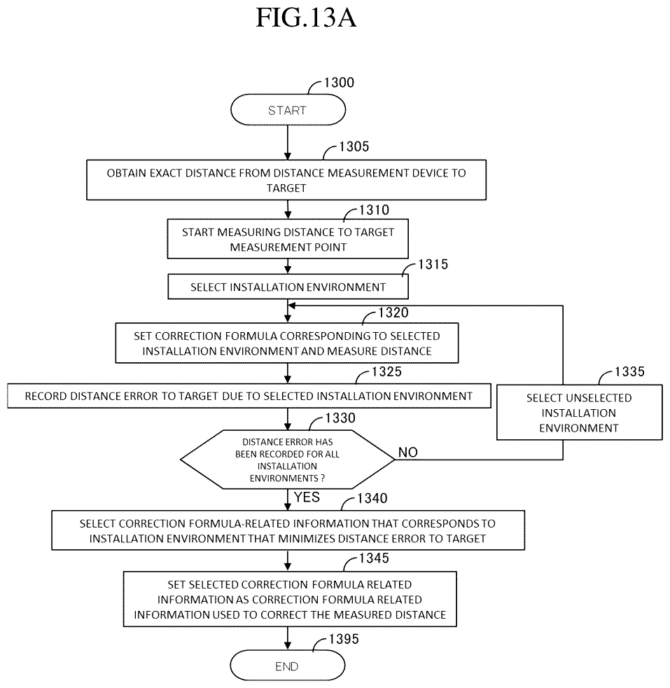

FIG. 12 shows an example of GUI screen GM1, which constitutes GUI (Graphical User Interface (GUI)) used to execute the process of setting the correction formula. The GUI screen GM1 includes an input field 1211 to input an actual distance to the target, a calibration start button 1212, and a target designation image 1213.

The actual distance to the target is entered in the input field 1211. The target is the measurement object used to set (select) the “two correction formulas and the range of application of each correction formula” that is optimal for the installation environment. The process of setting the “two correction formulas and the applicable range of each correction formula” optimal for the installation environment may also be referred to as “calibration.

The calibration start button 1212 is a button consisting of an image that allows the distance measurement device 100 to start calibration.

The target designation image 1213 is an image used to designate a measurement point (a target measurement point) for the measured distance of the target in the image. This image may be a distance image or an IR image. For example, the user can specify the measurement point of the target by operating the input device, such as by aligning the cursor on the target and performing a specific operation.

The GUI screen GM1 is displayed on a display device, such as a display connected to the external processing device 200. The user operates the GUI (inputs information to the GUI screen GM1) via an input device such as a mouse, keyboard, etc., connected to the external processing device 200. The external processing device 200 transmits the information entered on the GUI screen GM1 to the distance measurement device 100. The distance calculation unit 142 of the distance measurement device 100 acquires the information entered on the GUI screen GM1 transmitted from the external processing device 200.

The user specifies the target measurement point and inputs the distance to the target by operating the GUI. The distance calculation unit 142 of the distance measurement device 100 starts the process of setting the correction formula when the calibration start button 1212 is operated by the user with the target measurement point and the actual distance to the target input on the GUI screen GM1.

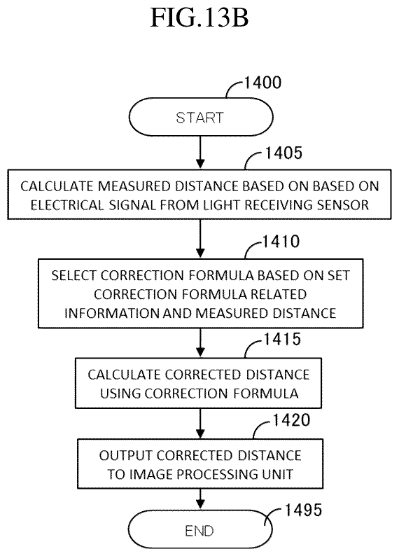

FIG. 13A is a flowchart showing the processing flow of the correction formula setting process executed by the distance calculation unit 142. When the calibration start button 1212 is operated by the user, the distance calculation unit 142 starts processing from step 1300 in FIG. 13A, executes steps 1305 through 1325 described below in sequence, and then proceeds to step 1330.

Step 1305: The distance calculation unit 142 obtains the exact distance to the target measurement point entered by the user on the GUI screen GM1.

Step 1310: The distance calculation unit 142 starts measuring the distance to the target measurement point.

Step 1315: The distance calculation unit 142 selects one installation environment for the correction table 710.

Step 1320: The distance calculation unit 142 obtains the correction formula related information corresponding to the selected installation environment from the correction table 710. Based on the correction formula related information, the distance calculation unit 142 sets “two correction formulas and the applicable range of each correction formula” corresponding to the installation environment. The distance calculation unit 142 measures the distance to the target (target measurement point) using the correction formula appropriate for the measured distance.

Step 1325: The distance calculation unit 142 calculates the distance error, which is the difference between the measured distance and the exact distance to the target measurement point (the exact distance is the actual distance entered in the input field 1211 of the GUI screen GM1), and stores it in the correction table memory 144 as the distance error corresponding to the selected installation environment (record).

The distance calculation unit 142 proceeds to step 1330 to determine whether the distance error has been recorded for all installation environments stored in the correction table 710.

When the distance error is not recorded for all installation environments stored in the correction table 710, the distance calculation unit 142 makes a “NO” determination at step 1330 and proceeds to step 1335 to select an unselected installation environment among the installation environments stored in the correction table 710.

The distance calculation unit 142 then returns to step 1320 and again performs steps 1320 and 1325 in sequence and proceeds to step 1330.

When the process of steps 1320 through 1335 is performed repeatedly and the distance error is recorded for all installation environments stored in the correction table 710 at step 1330, the distance calculation unit 142 makes a “YES” determination at step 1330 and performs steps 1340 and step 1345 in sequence. The distance calculation unit 142 then proceeds to step 1395 to tentatively terminate this processing flow.

Step 1340: The distance calculation unit 142 identifies the installation environment corresponding to the smallest recorded distance error to the target and selects the correction formula related information in the correction table 710 corresponding to the identified installation environment.

Step 1345: The distance calculation unit 142 sets the selected correction formula related information as the correction formula related information used to correct the measured distance.

FIG. 13B is a flowchart showing the processing flow executed by the distance calculation unit 142. The distance calculation unit 142 outputs the corrected distance (distance data) for each pixel to the image processing unit 143 by executing the processing flow shown in FIG. 13B every time a predetermined time elapses.

The distance calculation unit 142 starts processing from step 1400 in FIG. 13B, executes steps 1405 through 1420 described below, and then proceeds to step 1495 to tentatively terminate this processing flow.

Step 1405: The distance calculation unit 142 calculates the measured distance for each pixel based on the electrical signal (exposure amount) from the light receiving sensor 120.

Step 1410: At step 1345, the distance calculation unit 142 sets (selects) a correction formula to be applied based on the correction table 710 (correction formula related information (hereinafter referred to as “set correction formula related information”) set as correction formula related information to be used for the calculated distance and the measured distance.

Specifically, when the measured distance is between A and B, the distance calculation unit 142 applies the values of the slope 712a and offset 712b of the set correction formula related information stored in the between A-B correction 712 to the correction formula with the coefficients as variables. The distance calculation unit 142 sets this correction formula as the correction formula used for the distance correction. When the measured distance is between B and C, the distance calculation unit 142 sets, as the correction formula used for the distance correction, the correction formula that applies the values of the slope 713a and the offset 713b of the set correction formula related information stored in the between B-C correction 713 to the correction formula that uses the coefficients as variables.

Step 1415: The distance calculation unit 142 calculates the corrected distance for each pixel by correcting the measured distance for each pixel using the correction formula set at step 1410.

Step 1420: The distance calculation unit 142 outputs the calculated corrected distance (distance data) for each pixel to the image processing unit 143.

<Effect>

As explained above, the distance measurement device 100 according to the second embodiment of the present invention corrects the measured distance using the “plurality of correction formulas and the applicable range of each correction formula” best suited to the installation environment selected (set) from the plurality of “plurality of correction formulas and the applicable range of each correction formula”. As a result, the distance measurement device 100 can easily correct distance error caused by the multipath phenomenon more accurately without requiring troublesome work to generate correction formulas.

### Variation of Second Embodiment

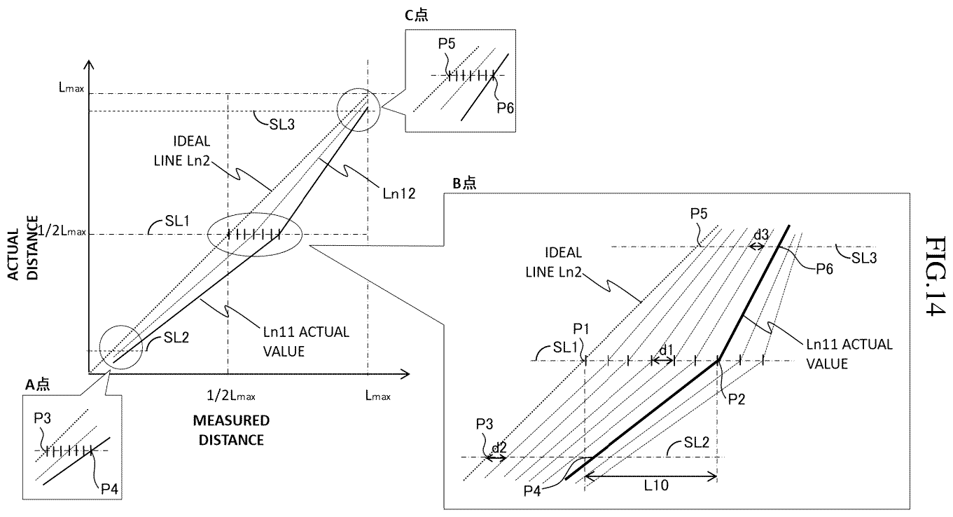

In the second embodiment, the control unit 140 of the distance measurement device 100 may be equipped with an automatic correction formula generation unit (not shown). FIG. 14 illustrates the method of generating correction formulas. It should be noted that the external processing device 200 may have the function of the automatic correction formula generation unit.

The measured line Ln11 is a line indicating the correction formula based on the measured values. When information representing the measured line Ln11 indicating the correction formula based on the actual measurement values is input, the automatic correction formula generation unit generates a correction formula based on the measured line Ln11.

The automatic correction formula generation unit calculates the predetermined interval d1 by dividing the distance L10 by a predetermined number n1 (n1=6 in this example). The distance L10 is a distance between “the intersection point P1 of the ideal line Ln2 and the line (dashed line SL1) with actual distance ½ Lmax on the straight line (dashed line SL1) at point B with actual distance ½ Lmax” and “the intersection point P2 of the measured line Ln11 and the straight line (dashed line SL1) with actual distance ½ Lmax”.

The automatic correction formula generation unit plots a predetermined number of points n2 (n2=8 in this example) at each predetermined interval d1 in the direction of a longer measurement distance from the intersection point P1 between the ideal line Ln2 and the ½ Lmax straight line (dashed line SL1). This plotted predetermined number of points are referred to as the “first points”.

The automatic correction formula generation unit calculates the predetermined interval d2 by dividing the distance between “an intersection point P3 and an intersection point P4” on the straight line (dashed line SL2) of the distance of point A where the actual distance is shorter than ½ Lmax. The intersection point P3 is an intersection point of the ideal line Ln2 and the straight line (dashed line SL2). The intersection point P4 is an intersection point of the measured line Ln11 and the straight line (dashed line SL2).

The automatic correction formula generation unit plots a predetermined number n2 of points at every predetermined interval d2 in the direction of the greater measurement distance from the intersection point P3 of the ideal line Ln2 and the straight line (dashed line SL2) of the distance of point A. It should be noted that this plotted predetermined number of points is referred to as the “second points”.

The automatic correction formula generation unit divides the distance between “the intersection point P5 of the ideal line Ln2 and the straight line (dashed line SL3) of the distance of the C point on the straight line of the distance of the C point (dashed line SL3), where the actual distance is longer than ½ Lmax”, and “the intersection point P6 of the line Ln11 of the distance of the C point (dashed line SL3)”, by a predetermined number n1, to thereby calculate the predetermined interval d3.

The automatic correction formula generation unit plots a predetermined number n2 of points at every predetermined interval d3 in the direction of the greater measurement distance from the intersection point P5 of the ideal line Ln2 and the straight line (dashed line SL3) of the distance of point C. This plotted predetermined number of points is referred to as the “third points”.

The automatic correction formula generation unit generates a plurality of straight lines by connecting between each of the first points, the second points, and the third points whose order corresponds when counted in the direction of greater measurement distance from the intersection with the ideal line Ln2.

From these multiple lines, the automatic correction formula generation unit obtains the correction formula that represents each line and the inflection point.

The automatic correction formula generation unit obtains the coefficients from each correction formula and the correction switching distance from each inflection point, generates multiple pieces of correction formula related information by mapping them to the installation environment identification information (name of the installation environment), and stores multiple pieces of correction formula related information in the correction table 710 stored in the correction table memory 144.

<Effect>

According to the variant of the second embodiment, the distance measurement device 100 can automatically generate a plurality of “plurality of correction formulas and applicable ranges of each correction formula” from correction formulas based on actual measured values. This allows the variant of the second embodiment to reduce the time and effort required to generate the plurality of “plurality of correction formulas and applicable ranges of each correction formula.

### Third Embodiment

The distance measurement device 100 according to the third embodiment of the present invention will be described. The distance measurement device 100 according to the third embodiment differs from the distance measurement device 100 according to the second embodiment only in the following points. The distance measuring device 100 according to the third embodiment sets the optimal correction formula for each divided image area.

The following explanation focuses on these differences.

<Overview>

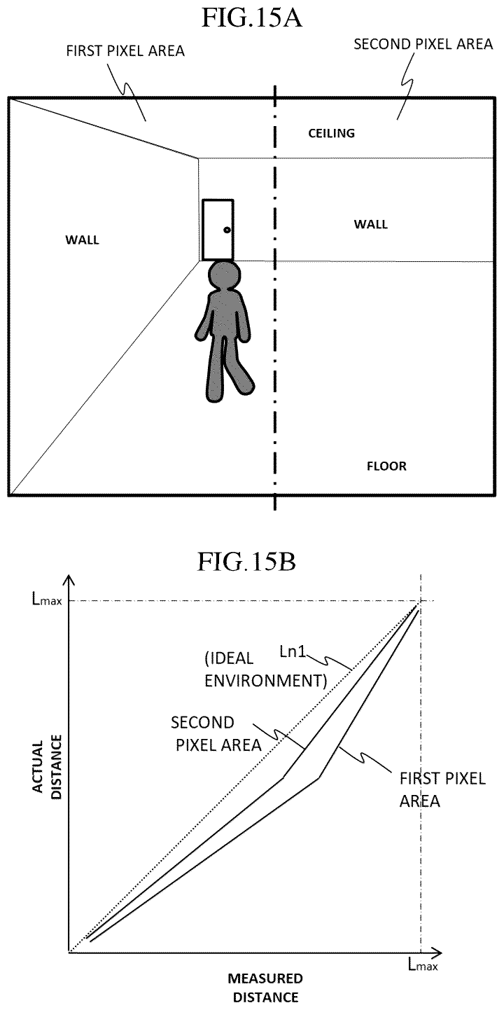

FIG. 15A and FIG. 15B illustrate the overview of the distance measurement device 100 according to the third embodiment. Due to the different degree of multipath influence depending on the room area, it can happen that the lines showing the relationship between the measured distance and the actual distance are different. In this case, as shown in FIG. 15A and FIG. 15B, the optimal “two correction formulas and the applicable range of each correction formula” differ for each image area. Therefore, the distance measurement device 100 sets the optimal “two correction formulas and the applicable range of each correction formula” for each image area.

<Specific Operation>

Although the figure is omitted, for example, the GUI screen GM1 allows the user to operate an input device to input lines indicating the boundaries that divide the image on the GUI screen GM1.

By operating the input device, the user inputs line indicating the boundary to be divided on the GUI screen GM1, the specification of the target measurement point, and the actual distance to the target measurement point for each image area after being divided by the line.

When the user operates the calibration start button 1212 with the lines indicating the boundaries to be divided, the designation/specification of the target measurement point for each image area after division, and the actual distance to the target measurement point entered on the GUI screen GM1, the distance calculation unit 142 of the distance measurement device 100 starts correction formula setting process.

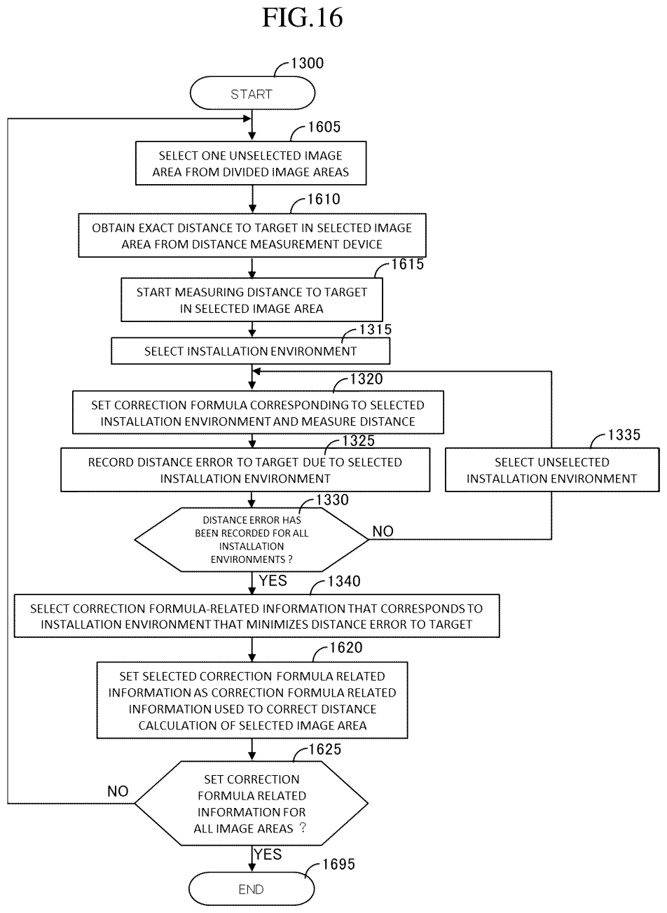

FIG. 16 is a flowchart showing the processing flow of the correction formula setting process executed by the distance calculation unit 142. When the calibration start button 1212 is operated by the user, the distance calculation unit 142 starts processing from step 1600 in FIG. 16 and performs steps 1605 through 1615 in the following order.

Step 1605: The distance calculation unit 142 selects one unselected image area among the divided image areas.

Step 1610: The distance calculation unit 142 obtains the exact distance from the “distance measurement device 100” to the “target measurement point in the selected image area”.

Step 1615: The distance calculation unit 142 starts measuring the distance from the “distance measurement device 100” to the “target measurement point in the selected image area”.

The distance calculation unit 142 then performs steps 1315 through 1340 as previously described. Thereby, the distance calculation unit 142 selects, for the selected image area, the correction formula related information corresponding to the installation environment that minimizes the distance error to the target.

The distance calculation unit 142 then proceeds to step 1620, sets the selected correction formula related information as the correction formula related information to be used to correct the distance calculation for the measurement object in the selected image area, and then proceeds to step 1625.

The distance calculation unit 142 proceeds to step 1625 to determine whether the “correction formula related information” used for correction has been set for all image areas.

When the “correction formula related Information” used for correction has not been set for all image areas, the distance calculation unit 142 makes a “NO” determination at step 1625 and returns to step 1605.

When the “correction formula related Information” used for correction has been set for all image areas, the distance calculation unit 142 makes a “YES” determination at step 1625 and proceeds to step 1695 to tentatively terminate this processing flow.

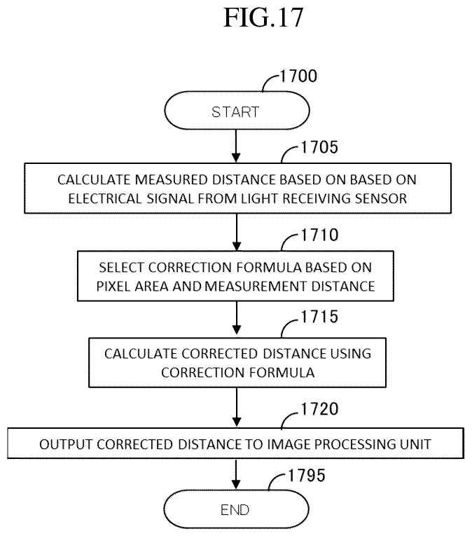

FIG. 17 is a flowchart showing the processing flow executed by the distance calculation unit 142. The distance calculation unit 142 outputs the corrected distance (distance data) for each pixel to the image processing unit 143 by executing the processing flow shown in FIG. 17 every time a predetermined time elapses.

The distance calculation unit 142 starts processing from step 1700 in FIG. 17, executes steps 1705 through 1720 described below, and then proceeds to step 1795 to tentatively terminate this processing flow.

Step 1705: The distance calculation unit 142 calculates the measured distance for each pixel based on the electrical signal (the exposure amount) from the light receiving sensor 120.

Step 1710: The distance calculation unit 142 sets (selects) the correction formula to be applied based on the image area, measured distance, and correction table 710 (correction formula related information (set correction formula related information) set for each image area at step 1620).

For example, assume that the image area is divided into a first image area and a second image area. In this case, when the pixel area in which the object to be measured exists is the first image area, and the measured distance is between A and B, the distance calculation unit 142 applies the slope 712a of the set correction formula related information for the first image area stored in the between A-B correction 712 and the offset 712b to the correction formula with the coefficients as variables. The distance calculation unit 142 then sets this correction formula as the correction formula used for the distance correction. When the pixel area where the object to be measured exists is the first image area and the measured distance is between B and C, the distance calculation unit 142 applies values of the slope 713a and the offset 713b of the set correction formula related information for the first area stored in the between B-C correction 713 to the correction formula with the coefficients as variables. The distance calculation unit 142 sets this correction formula as the correction formula used for distance correction.

When the pixel area in which the object to be measured exists is the second image area and the measured distance is between A and B, the distance calculation unit 142 applies values of the slope 712a and the offset 713b of the set correction formula related information for the second image area stored in the between A-B correction 712 to the correction formula with the coefficients as variables. The distance calculation unit 142 then sets this correction formula as the correction formula used for the distance correction. When the pixel area where the object to be measured exists is the second image area and the measured distance is between B and C, the distance calculation unit 142 applies values of the slope 713a and the offset 713b of the set correction formula related information for the second image area stored in the between B-C correction 713 to the correction formula with the coefficients as variables. The distance calculation unit 142 sets this correction formula as the correction formula used for distance correction.

Step 1715: The distance calculation unit 142 calculates the corrected distance by correcting the measured distance using the correction formula set at step 1710.

Step 1720: The distance calculation unit 142 outputs the calculated corrected distance (distance data) for each pixel to the image processing unit 143.

<Effect>

As explained above, the distance measurement device 100 according to the third embodiment of the present invention corrects the measured distance for each image area using the “plurality of correction formulas and the applicable range of each correction formula” best suited to the installation environment selected (set) from the plurality of correction formulas and the applicable range of each correction formula. This allows the distance measurement device 100 to easily correct distance error caused by the multipath phenomenon more accurately without requiring troublesome work to generate correction formulas.

### Fourth Embodiment

The distance measurement device 100 according to the fourth embodiment of the present invention will be described. The distance measurement device 100 according to the fourth embodiment of the present invention differs from the distance measurement device 100 according to the second embodiment only in the following points. The distance measurement device 100 according to the fourth embodiment sets the optimal “two correction formulas and the applicable range of each correction formula” according to the changed state when the state of the installation environment changes.

The following explanation focuses on these differences.

<Overview>

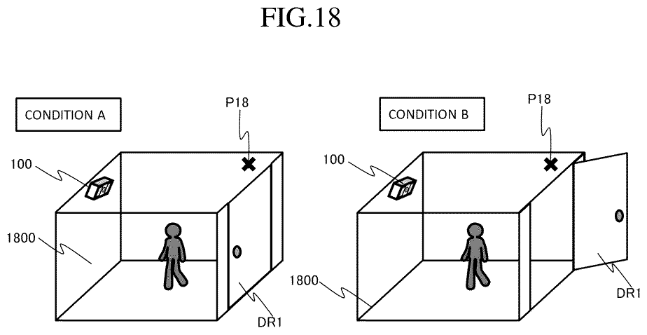

FIG. 18 illustrates an overview of the distance measurement device 100 according to the fourth embodiment. As shown in FIG. 18, in a relatively small room 1800, the opening and closing of door DR1 causes a distance error due to multipath. For example, the degree of influence of multipath on the distance error is greater in state A, where the door DR1 is closed, than in state B, where the door DR1 is open. Therefore, even in the same installation environment, the optimal “two correction formulas and the applicable range of each correction formula” differ depending on the state of the installation environment.

Therefore, the distance measurement device 100 according to the fourth embodiment measures to the fixed point P18 to determine that the state has changed based on the change in the distance measured to the fixed point P18. The distance measurement device sets “two correction formulas and the applicable range of each correction formula” according to the state when the state changes, and corrects the measured distance using the correction formulas according to the measured distance based on the “two correction formulas and the applicable range of each correction formula”.

This enables the distance measurement device 100 to accurately measure the distance to the object to be measured by reducing the deterioration of the linearity of the distance measurement results. Since the distance measurement device 100 uses correction formulas stored in the correction table memory 144 in advance according to the installation environment and its conditions, there is no need for the operator to work to set correction formulas, as in Patent Document 1 (Japanese Unexamined Patent Application Publication No. 2021-117036), so the distance measurement device 100 can easily correct the distance error caused by the multi-path phenomenon.

<Configuration>

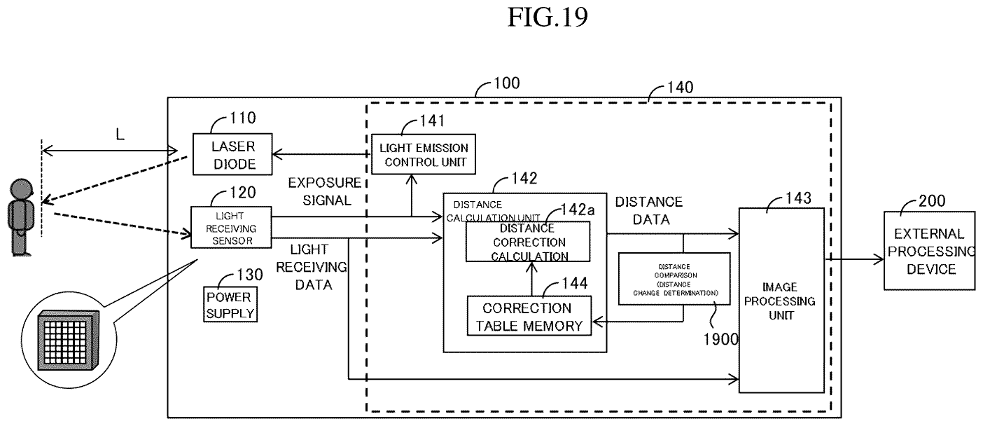

FIG. 19 shows an example configuration of the distance measurement device 100 according to the fourth embodiment of the present invention. As shown in FIG. 19, the distance measurement device 100 is equipped with a distance comparison unit 1900. The distance comparison unit 1900 obtains the corrected distance of the fixed point P18 from the distance calculation unit 142 every time a predetermined time elapses. The distance comparison unit 1900 calculates the distance change (e.g., the amount of distance change per predetermined time) based on the corrected distance of the fixed point P18, determines the state change of the installation environment based on the distance change, and inputs the determination result to the distance calculation unit 142. Other than the above points, the distance measurement device 100 is the same as the distance measurement device 100 shown in FIG. 1.

<Specific Operation>

The user inputs the state of the installation environment to be set, the designation of the target measurement point, and the actual distance to the target measurement point on the GUI screen GM1 by operating the input device. Although not shown in the figure, the GUI screen GM1 allows the user to input the name of one or more states of the installation environment to be set.

The distance calculation unit 142 of the distance measurement device 100 starts the process of setting the correction formula when the calibration start button 1212 is operated by the user with the state of the installation environment to be set, the target measurement point designation, and the actual distance to the target entered on the GUI screen GM1.

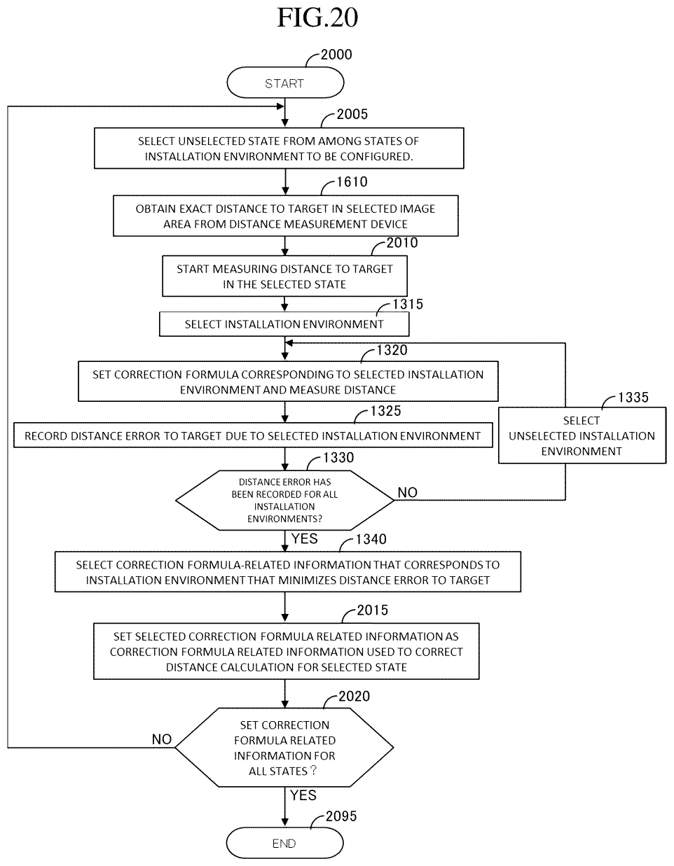

FIG. 20 is a flowchart showing the processing flow of the setting process of the correction formula executed by the distance calculation unit 142. When the calibration start button 1212 is operated by the user, the distance calculation unit 142 starts processing from step 2000 in FIG. 20 and proceeds to step 2005 to select one of the unselected states of the installation environment to be set.

Thereafter, the distance calculation unit 142 executes step 1610 as previously described, and then proceeds to step 2010 to start measuring the distance to the target measurement point in the selected state. Thereafter, the distance calculation unit 142 performs steps 1315 through 1340 as previously described. Thereby, the distance calculation unit 142 selects the correction formula related information corresponding to the installation environment that minimizes the distance error to the target for the selected state.

The distance calculation unit 142 then proceeds to step 2015 and sets the selected correction formula related information as the “correction formula related information” to be used to correct the distance calculation in the selected state, and then proceeds to step 2020.

The distance calculation unit 142 proceeds to step 2020 to determine whether the “correction formula related information” used for correction has been set for all states.

When the “correction formula related information” used for correction is not set for all states, the distance calculation unit 142 makes a “NO” determination at step 2020 and returns to step 2005.

When the “correction formula related information” used for correction is set for all states, the distance calculation unit 142 makes a “YES” determination at step 2020 and proceeds to step 2095 to tentatively terminate this processing flow.

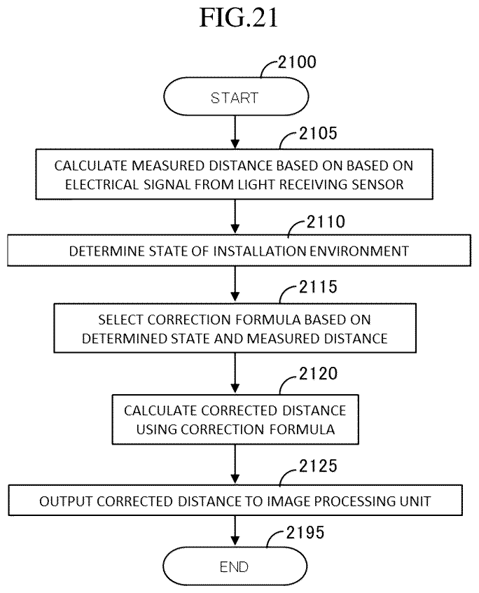

FIG. 21 is a flowchart showing the processing flow executed by the distance calculation unit 142. The distance calculation unit 142 outputs the corrected distance (distance data) for each pixel to the image processing unit 143 by executing the processing flow shown in FIG. 21 every time a predetermined time elapses.

The distance calculation unit 142 starts processing from step 2100 in FIG. 21 and performs steps 2105 through 2125 described below in sequence, then proceeds to step 2195 to tentatively terminate this processing flow.

Step 2105: The distance calculation unit 142 calculates the measured distance for each pixel based on the electrical signal (the exposure amount) from the light receiving sensor 120.

Step 2110: The distance calculation unit 142 determines the state of the installation environment based on the result of the determination of the state of the installation environment by the distance comparison unit 1900. The determination of the state of the installation environment by the distance comparison unit 1900 is performed as follows. For example, the initial setting state is set to one of state A and state B according to the actual state of the installation environment. In the following description, it is assumed that the initial setting state is state A. The distance comparison unit 1900 obtains the distance change of the corrected distance to the fixed position per predetermined time. The distance comparison unit 1900 determines whether the absolute value of the distance change is greater than or equal to the threshold value. When the absolute value of the distance change is greater than or equal to the threshold value, the distance comparison unit 1900 determines that the state has changed from state A to state B (i.e., determines the state as state B)). When the absolute value of the distance change is less than the threshold value, the distance comparison unit 1900 determines that the state has not changed from state A to state B (i.e., determines the state as state A).

On the other hand, when the absolute value of the distance change is greater than or equal to the threshold value in state B, the distance comparison unit 1900 determines that the distance has changed from state B to state A (i.e., determines the state as state A). When the absolute value of the distance change is less than the threshold value, the distance comparison unit 1900 determines that the state has not changed from state B to state A (i.e., determines the state as state B).

Step 2115: The distance calculation unit 142 sets (selects) the correction formula to be applied based on the determined state, the measured distance and the correction table 700 (correction formula related information (set correction formula related information) set for each state at step 2015).

When the determined state is state A and the measured distance is between A and B, the distance calculation unit 142 applies the values of slope 712a and offset 712b of the set correction formula related information for state A stored in the A to B correction 712 to the correction formula with the coefficient as a variable. The distance calculation unit 142 then sets this correction formula as the correction formula used for the distance correction. When the determined state is state A and the measured distance is between B and C, the distance calculation unit 142 applies the values of the slope 713a and the offset 713b of the set correction formula related information for state A stored in the between B-C correction 713 to the correction formula with the coefficient as a variable. The distance calculation unit 142 sets this correction formula as the correction formula used for the distance correction.

When the determined state is state B and the measured distance is between A and B, the distance calculation unit 142 applies the values of slope 712a and the offset 712b of the set correction formula related information for state B stored in the between A-B correction 712 to the correction formula with the coefficient as a variable. The distance calculation unit 142 then sets this correction formula as the correction formula used for the distance correction. When the determined state is state B and the measured distance is between B and C, the distance calculation unit 142 applies the values of slope 713a and the offset 713b of the set correction formula related information for state B stored in the between B-C correction 713 to the correction formula that uses the coefficients as variables. The distance calculation unit 142 sets this correction formula as the correction formula used for the distance correction.

Step 2120: The distance calculation unit 142 calculates the corrected distance by correcting the measured distance using the correction formula set at step 2115.

Step 2125: The distance calculation unit 142 outputs the calculated corrected distance (distance data) for each pixel to the image processing unit 143.

<Effect>

As explained above, the distance measurement device 100 according to the fourth embodiment of the present invention corrects the measured distance using the “plurality of correction formulas and the applicable range of each correction formula” best suited to the installation environment selected (set) from the plurality of “plurality of correction formulas and the applicable range of each correction formula” for each installation environment condition. This allows the distance measurement device 100 to easily correct distance error caused by the multipath phenomenon more accurately without requiring troublesome work to generate correction formulas.

### Other Modified Examples

The present invention is not limited to the above embodiments and the above variations, and various variations can be adopted within the scope of the present invention. Furthermore, the above embodiments and the above variations can be combined with each other as long as they do not depart from the scope of the present invention.

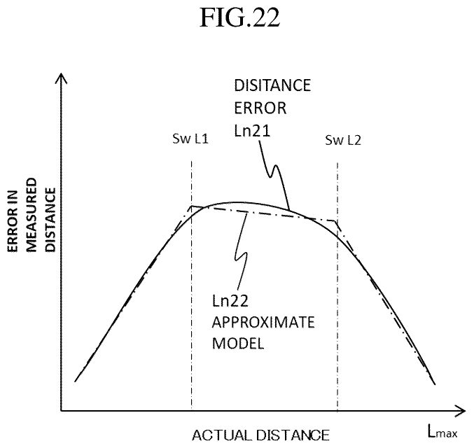

Depending on the installation environment, the relationship between the actual distance and the measurement error may have the shape shown in line Ln21 in FIG. 22. In this case, it is better to establish an approximate model (line Ln22) with three lines with different slopes and intercepts than an approximate model with two lines with different slopes and intercepts to obtain a better correction effect. Therefore, three approximate correction formulas may be established for the measured distance from such an approximate model.

In this case, for example, a correction formula (Y=aX+b) with the coefficients as variables, identification information indicating the installation environment, values of the coefficients of the correction formulas for each applicable range, and two correction switching distances (SwL1 and SwL2) are stored in the correction table 710 as correction formula related information, which are associated with each other. The distance calculation unit 142 sets the correction formulas to be used for correction and the applicable range of the correction formulas from the information related to the correction formulas. In each of the above formulations, there may be four or more correction formulas (approximate correction formulas) for each applicable range.

The present invention can also be configured as follows.

[1] A distance correction method applied to a distance measurement device comprising:
an irradiation unit that irradiates measurement light onto an object to be measured;
a light receiving sensor that receives reflected light from the object to be measured and detects an exposure amount based on the reflected light; and
a control unit that includes a memory unit that stores correction information indicating a correction formula set including a plurality of correction formulas and an applicable distance range of each correction formula, and calculates a measured distance to the object to be measured based on the exposure amount, the distance correction method to be performed using the control unit, the distance correction method comprising:
selecting, based on the correction information stored in the memory, the correction formula that corresponds to the applicable distance range in which the measured distance is included among the correction formulas in the correction formula set; and
calculating a corrected measured distance by correcting the measured distance using the selected correction formula.

[2] A non-transitory computer-readable storage medium storing a computer-executable program executed by a control unit of a distance measurement device comprising:
an irradiation unit that irradiates measurement light onto an object to be measured;
a light receiving sensor that receives reflected light from the object to be measured and detects an exposure amount based on the reflected light; and
the control unit that includes a memory unit that stores correction information indicating a correction formula set including a plurality of correction formulas and an applicable distance range of each correction formula, and calculates a measured distance to the object to be measured based on the exposure amount, the program comprising instructions for:
selecting, based on the correction information stored in the memory, the correction formula that corresponds to the applicable distance range in which the measured distance is included among the correction formulas in the correction formula set; and
calculating a corrected measured distance by correcting the measured distance using the selected correction formula.

What is claimed is:

1. A distance measurement device comprising:
an irradiation unit that irradiates measurement light onto an object to be measured;
a light receiving sensor that receives reflected light from the object to be measured and detects an exposure amount based on the reflected light; and
a control unit that includes a memory unit that stores correction information indicating a correction formula set including a plurality of correction formulas and an applicable distance range of each correction formula, and calculates a measured distance to the object to be measured based on the exposure amount,
wherein,
the control unit is configured to perform, based on the correction information stored in the memory, a distance correction calculation to:
select the correction formula that corresponds to the applicable distance range in which the measured distance is included among the correction formulas in the correction formula set; and
calculate a corrected measured distance by correcting the measured distance using the selected correction formula.

2. The distance measurement device according to claim 1,
wherein,
the correction information is information indicating a plurality of the correction formula sets corresponding to each of a plurality of installation environments; and
the control unit is configured to:
calculate, for each of the correction formula sets, the measured distance to a predetermined object to be measured based on the correction information stored in the memory;
perform distance difference calculation to calculate, for each of the correction formula sets, a corrected measured distance by correcting the measured distance using the correction formula included in the correction formula set corresponding to the applicable distance range in which the measured distance is included, to thereby calculate a distance difference between an actual distance to the predetermined object to be measured and the calculated corrected measured distance;
set the correction formula set that includes the correction formula used to obtain the smallest distance difference among the distance differences calculated for each of the plurality of the correction formula sets as the correction formula set used for the distance correction calculation; and
perform the distance correction calculation using the correction formula set up above.

3. The distance measurement device according to claim 2,
wherein,
the control unit is configured to:
acquire information based on light received by the light receiving sensor from the light receiving sensor; and
generate an image of a distance measurement target range based on the acquired information; and
the control unit is configured to:
perform, for each of a plurality of image areas into which the image is divided, the distance difference calculation with the predetermined object to be measured present in each image area as a target for calculating the distance difference,
set, for each image area, the correction formula set including the correction formula used to obtain the smallest distance difference among the distance differences calculated for each of the plurality of the correction formula sets, as the correction formula set used in the distance correction calculation when correcting the measured distance of the object to be measured present in each image area;
identify the image area in which the object to be measured is located; and
use the correction formula set that has been set for the identified image area where the object to be measured is located for the distance correction calculation.

4. The distance measurement device according to claim 2,
wherein,
the control unit is configured to:
perform the distance difference calculation for each of a plurality of states of the installation environment in which the object to be measured exists;
set, for each state, the correction formula set including the correction formula used to obtain the smallest distance difference among the distance differences calculated for each of the plurality of correction formula sets, as the correction formula set used in the distance correction calculation when correcting the measured distance of the object to be measured when the installation environment is in each state;
determine the state of the installation environment in which the object to be measured is located; and
use the correction formula set that has been set for the state of the installation environment where the object to be measured is located for the distance correction calculation.

5. The distance measurement device according to claim 4,
wherein,
the control unit is configured to:
calculate the corrected measured distance of a fixed measurement point in the installation environment every time a predetermined time elapses; and
determine the state of the installation environment based on an amount of change in the corrected measured distance.

6. The distance measurement device according to claim 2,
wherein,
the control unit is configured to:
generate, based on information indicating two correction formulas and the applicable distance range of each correction formula based on actual measurement values, the correction information indicating the correction formula sets stored in the memory unit.

7. The distance measurement device according to claim 1,
wherein,
the correction formulas are two correction formulas consisting of linear functions whose slopes and intercepts differ from each other.

8. The distance measurement device according to claim 1,
wherein,
the correction formulas are three or more correction formulas consisting of linear functions whose slopes and intercepts differ from each other.

9. The distance measurement device according to claim 1,
wherein,
the memory unit stores, as the correction information,
a correction formula with coefficients as variables, the correction formula corresponding to an approximate model that approximates a relationship between a measurement error caused by multipath in an installation environment and an actual distance; and
correction formula related information in which identification information indicating the installation environment, a switching distance of the correction formula, and coefficients corresponding to each applicable distance range classified based on the switching distance of the correction formula correspond to each other.

10. A distance correction method applied to a distance measurement device comprising:
an irradiation unit that irradiates measurement light onto an object to be measured;
a light receiving sensor that receives reflected light from the object to be measured and detects an exposure amount based on the reflected light; and
a control unit that includes a memory unit that stores correction information indicating a correction formula set including a plurality of correction formulas and an applicable distance range of each correction formula, and calculates a measured distance to the object to be measured based on the exposure amount, the distance correction method to be performed using the control unit, the distance correction method comprising:
selecting, based on the correction information stored in the memory, the correction formula that corresponds to the applicable distance range in which the measured distance is included among the correction formulas in the correction formula set; and
calculating a corrected measured distance by correcting the measured distance using the selected correction formula.

11. A non-transitory computer-readable storage medium storing a computer-executable program executed by a control unit of a distance measurement device comprising:
an irradiation unit that irradiates measurement light onto an object to be measured;
a light receiving sensor that receives reflected light from the object to be measured and detects an exposure amount based on the reflected light; and
the control unit that includes a memory unit that stores correction information indicating a correction formula set including a plurality of correction formulas and an applicable distance range of each correction formula, and calculates a measured distance to the object to be measured based on the exposure amount, the program comprising instructions for:
selecting, based on the correction information stored in the memory, the correction formula that corresponds to the applicable distance range in which the measured distance is included among the correction formulas in the correction formula set; and
calculating a corrected measured distance by correcting the measured distance using the selected correction formula.
